(19) United States
(12) Patent Application Publication
(10) Pub. No.: US 2010/0165491 A1
(43) Pub. Date: Jul. 1, 2010

(54) LENS MODULE AND CAMERA MODULE USING SAME

(75) Inventors: Kuan-ting Chen, Tu-Cheng (TW); Chun-hsiang Huang, Tu-Cheng (TW); Hsin-tsung Yeh, Tu-Cheng (TW); Wei-hsiu Chang, Tu-Cheng (TW); Kuang-wei Lin, Tu-Cheng (TW); Mei-chun Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/435,366

(22) Filed: May 4, 2009

(30) Foreign Application Priority Data
Dec. 25, 2008 (CN) 200810306540.7

(51) Int. Cl. G02B 7/02

(52) U.S. Cl. 359/819

(57) ABSTRACT

A lens module includes a lens barrel and a lens and an opaque adhesive layer. The lens includes a central imaging portion and a peripheral non-imaging portion. The lens is received in the lens barrel with the peripheral non-imaging portion contacting the lens barrel. The opaque adhesive layer is applied to a contact portion between the lens barrel and the lens to fixedly secure the lens to the lens barrel and configured for blocking light from entering through the peripheral non-imaging portion.

### BACKGROUND

1. Technical Field

The present disclosure relates to a lens module and a camera module using the same.

2. Description of Related Art

Optical lenses typically include a central imaging portion and a peripheral non-imaging portion. The central imaging portion modulates incident light rays into optical images. The peripheral non-imaging portion is for engagement of the optical lenses with the fixing structures. In general, the central imaging portion and the peripheral portion are, to reduce costs, integrally made from transparent material. Therefore, in use, light rays can also transmit to the non-imaging portion, degrading image quality.

Therefore, what is desired is a lens module and a camera module using the same that can overcome the above described limitations.

### BRIEF DESCRIPTION OF THE DRAWINGS

FIG. 1 is a schematic cross-section of a lens module, in according with one exemplary embodiment.

FIG. 2 is a schematic view of exemplary optical paths of the lens assembly of FIG. 1.

FIG. 3 is a schematic view of a camera module, in according with one exemplary embodiment.

### DETAILED DESCRIPTION

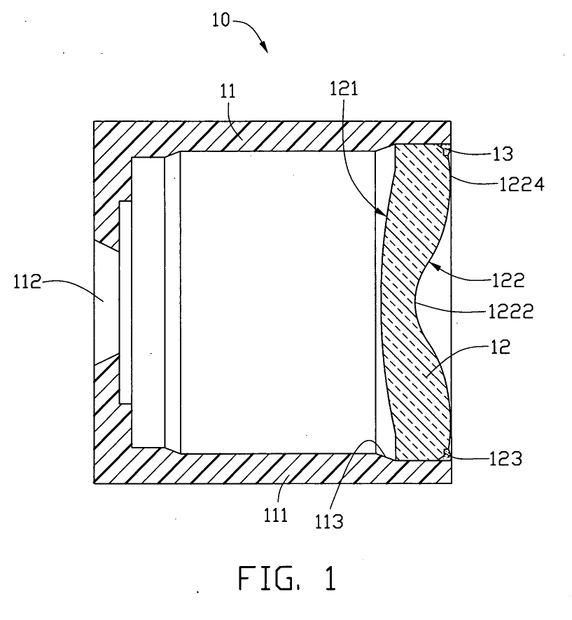

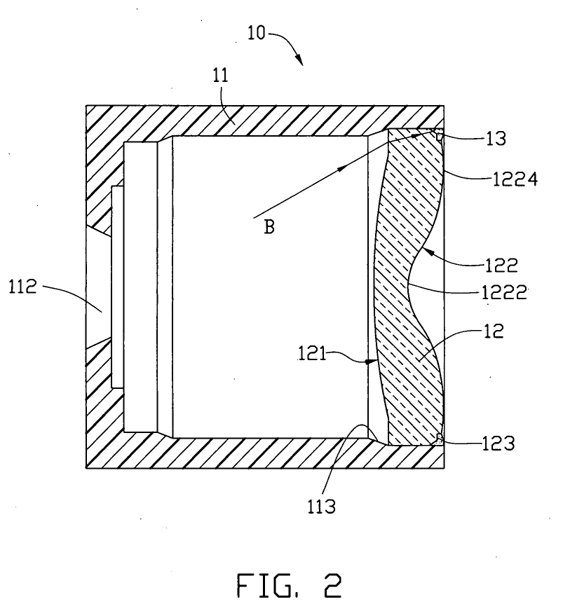

Referring to FIGS. 1-2, a lens module 10 in accordance with an exemplary embodiment is illustrated. The lens module 10 includes a lens barrel 11, a lens 12, and an opaque adhesive layer 13.

The lens barrel 11 is a hollow cylinder in shape, and includes a tube-shaped main body 111, an aperture portion 112, and a bearing portion 113. The aperture portion 112 is integrally formed at the object-side end of the main body 111, and is shaped and functions as an aperture stop. The bearing portion 113 is formed in the inner surface of the lens barrel 11 and configured for seating the lens 12 in the lens barrel 11.

The lens 12 can be made of plastic or glass, and includes an object-side surface 121 and an image-side surface 122. The image-side surface 122 is concave, and can be a spherical or aspherical surface. The lens 12 includes an imaging portion 1222 and a non-imaging portion 1224. The imaging portion 1222 modulates light rays from an object incident thereon to form an image of the object. The non-imaging portion 1224 engages the lens 12. In this embodiment, when the lens 12 is received in the lens barrel 11, the non-imaging portion 1224 grasps the lens barrel 11, forming a contact portion 123 therebetween, and is stopped by the bearing portion 113.

The opaque adhesive layer 13 is applied to the contact portion 123 to secure the lens 12 to the lens barrel 11. The opaque adhesive layer 13 is black and blocks light B passing through the non-imaging portion 1224, improving image quality of the imaging portion 1222.

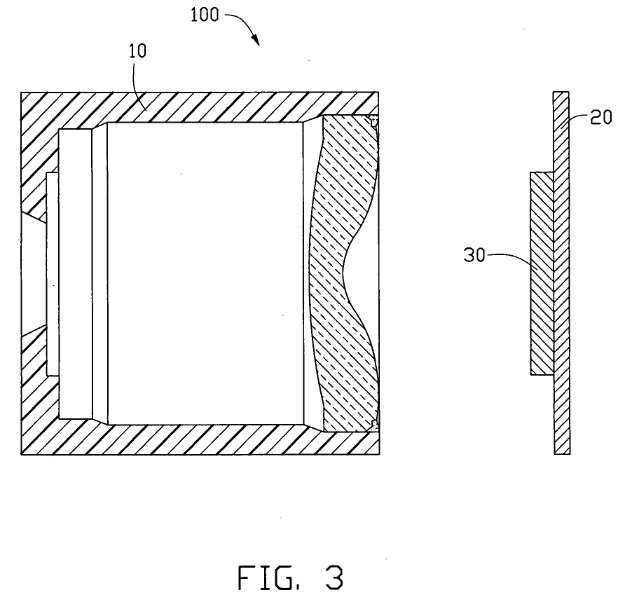

Referring to FIG. 3, a camera module 100 in accordance with an exemplary embodiment is illustrated. The camera module 100 includes a lens module 10 such as that in FIG. 1, a substrate 20, and an image sensor chip 30. The image sensor chip 30 is mechanically and electrically connected to the substrate 20, and positioned at the image side of the lens module 10. The lens module 10 is aligned with the image sensor chip 30 and is fixed to the substrate 20. The image sensor 30 can be, for example, a charged coupled device (CCD), image sensor or a complementary metal-oxide-semiconductor (CMOS) image sensor.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A lens module comprising:
a lens barrel;
a lens comprising a central imaging portion and a peripheral non-imaging portion, the lens being received in the lens barrel with the peripheral non-imaging portion contacting the lens barrel; and
an opaque adhesive layer applied to a contact portion between the lens barrel and the lens to secure the lens to the lens barrel, the opaque adhesive layer being further configured for blocking light from passing through the peripheral non-imaging portion.

2. The lens module as claimed in claim 1, wherein the opaque adhesive layer is black.

3. The lens module as claimed in claim 1, wherein the non-imaging portion is configured for engaging the lens with the lens barrel, when the lens is received in the lens barrel, the non-imaging portion grasping the lens barrel and forming the contact portion therebetween.

4. The lens module as claimed in claim 1, wherein the inner surface of the lens barrel defines a bearing portion, configured for seating the lens in the lens barrel, and the lens is stopped by the bearing portion.

5. The lens module as claimed in claim 1, wherein the lens comprises an object-side surface and an image-side surface, wherein the image-side surface is concave and is a spherical or aspherical surface.

6. The lens module as claimed in claim 1, wherein the lens is made of plastic or glass.

7. The lens module as claimed in claim 1, wherein the lens barrel comprises a tube-shaped main body and an aperture portion, the aperture portion integrally formed at the object-side end of the main body and shaped and acting as an aperture stop.

8. A camera module comprising:
a substrate;
an image sensor chip mechanically and electrically connected to the substrate; and
a lens module aligned with the image sensor chip and fixed to the substrate, and comprising:
a lens barrel;
a lens comprising a central imaging portion and a peripheral non-imaging portion, the lens being received in the lens barrel with the peripheral non-imaging portion contacting the lens barrel; and
an opaque adhesive layer applied to a contact portion between the lens barrel and the lens to fixedly secure the lens to the lens barrel, the opaque adhesive layer being further configured for blocking light from passing through the peripheral non-imaging portion.

9. The camera module as claimed in claim 8, wherein the opaque adhesive layer is black.

10. The camera module as claimed in claim 8, wherein the non-imaging portion is configured for engaging the lens with the lens barrel, and when the lens is received in the lens barrel, the non-imaging portion fixes the lens barrel, forming the contact portion therebetween.

11. The camera module as claimed in claim 8, wherein the inner surface of the lens barrel defines a bearing portion configured for seating the lens in the lens barrel, and the lens is stopped by the bearing portion.

12. The camera module as claimed in claim 8, wherein the lens comprises an object-side surface and an image-side surface, wherein the image-side surface is concave and is a spherical or aspherical surface.

13. The camera module as claimed in claim 8, wherein the lens is made of plastic or glass.

14. The camera module as claimed in claim 8, wherein the lens barrel comprises a tube-shaped main body and an aperture portion integrally formed at the object-side end of the main body and shaped and acting as an aperture stop.

15. The camera module as claimed in claim 8, wherein the image sensor chip is a charged coupled device (CCD), image sensor or a complementary metal-oxide-semiconductor (CMOS) image sensor.
